(19) United States
(12) Patent Application Publication
(10) Pub. No.: US 2016/0142429 A1
(43) Pub. Date: May 19, 2016

(54) PREVENTING ACCESS TO MALICIOUS CONTENT

(71) Applicant: Royce Renteria, Anoka, MN (US)

(72) Inventor: Royce Renteria, Anoka, MN (US)

(21) Appl. No.: 14/946,467

(22) Filed: Nov. 19, 2015

Related U.S. Application Data
(60) Provisional application No. 62/081,612, filed on Nov. 19, 2014.

(51) Int. Cl. H04L 29/06; H04L 12/58

(52) U.S. Cl. CPC H04L 63/1416; H04L 51/12; H04L 63/1433; H04L 63/0236

(57) ABSTRACT

System and techniques for preventing access to malicious websites are described herein. A communication message containing content may be received. A query may be generated based on the content of the communication message. The query may be executed against a database of known malicious content items and a score may be generated based on similarity of the content of the communication message to one or more of the known malicious content items. It may be determined whether to block the communication message based on the score relative to a predetermined threshold.

### CLAIM OF PRIORITY AND INCORPORATION BY REFERENCE

This application claims the benefit of U.S. Provisional Application Ser. No. 62/081,612, filed Nov. 19, 2014, and incorporates it by reference in its entirety.

### TECHNICAL FIELD

The present subject matter relates generally to network security systems, and methods, and particularly to Internet security systems and methods related to restricting access to malicious content.

### BACKGROUND

The inventor recognized that existing solutions for preventing internet users from falling prey to malicious web activity are not as effective as desired. Accordingly, the inventor recognized a need for better ways of preventing or reducing the risk of encountering malicious web content.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a block diagram of an example system for preventing access to malicious content, according to an embodiment of the present subject matter.

FIG. 2 illustrates a flow diagram of an example method for preventing access to malicious content, according to an embodiment of the present subject matter.

FIG. 3 illustrates a flow diagram of an example method for preventing access to malicious content, according to an embodiment of the present subject matter.

FIG. 4 illustrates a block diagram illustrating an example of a machine upon which one or more embodiments of the present subject matter may be implemented.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

To address one or more problems or shortcomings with existing solutions to malicious internet content, the present subject matter includes, among other things, one or more exemplary systems, methods, devices, components, and software for restricting access to malicious content. One exemplary method entails quarantining or marking emails as suspicious based at least on age of a domain associated with the one or more emails this and one or more other methods and approaches described herein promise to be particularly effective in thwarting spear phishing, malicious hyperlinks, malware, spam, malvertising, typosquatting attacks, zero-day attacks, cyber data ransoming threats, and other web-based threats.

In some embodiments, one or more email messages are received by an email server or other device (e.g., web server, network security appliance, network security application, etc.). In an example, the email(s) can be received by a filtering system that takes form of cloud, enterprise email server, and/or app (or other form of software or set of machine-executable instructions) on a network communication device (or network connected or network aware device such as, for example, an Internet of Things device). In some embodiments, a communication message (e.g., email message, data packets, website access request, a data stream, etc.) may be received by the filtering system.

Information is extracted from each of the received emails and/or communication messages. Examples of extracted information includes sender address, sender domain name, return path information, IP addresses, and embedded hyperlinks. In some embodiments, the information is extracted from the header of each email and/or a data packet of the communication message. In some embodiments, the information may be extracted from the content of the email and/or communication message (e.g., email message body, data packet contents, etc.).

Information from public whois data is retrieved or otherwise accessed based on one or more portions of the extracted information or information derived or inferred from the extracted information. Exemplary whois data includes registrar, registrant, reseller, domain age data, IP addresses. Some embodiments may also retrieve or access domain and IP address usage data or statistics.

In some embodiments, it is determined if one or more portions of retrieved information are listed on a private or public black/gray list of offenders or suspected offenders or other list of quarantined senders. If one or more portions of the retrieved information is listed on one or more of these lists, the email is quarantined and/or the communication message is blocked. In some embodiments, the email and/or communication message may be tagged or otherwise marked as suspicious, rather than being quarantined and/or blocked. In an example, a private blacklist may be created by collecting threat data gathered by users of the system and aggregating the user data to construct lists of known good, known bad, and suspicious content and/or content providers. In an example, the user data may be gathered automatically and/or may be self-reported by the users.

In some embodiments, it is determined if one or more domains associated with the email and/or communication message satisfy one or more predetermined age criteria or conditions. For example, some embodiments determine whether one or more of the domains associated with an email message and/or content of a communication message satisfy a minimum age requirement. If age criteria is not satisfied, the email message is quarantined or marked as suspicious and/or the communication message is blocked or marked as suspicious.

In some embodiments, it is determined whether one or more IP addresses associated with the email satisfy one or more predetermined geographic criteria or conditions. For example, one embodiment determines if the IP address is within or without a predetermined geographic region, for example a region known for originating malicious attacks. If the IP address meets the predetermined geographic criteria, then the email is quarantined or otherwise marked and/or the communication message blocked or marked as suspicious. In an example, the email message and/or communication message may be quarantined, blocked, or otherwise marked if the geographic region is flagged as outside a geographic region the user would communicate with (e.g., a region having a different language than the user, a region outside the user's typical business operations, etc.). In an example, the user's geolocation data may be collected and used to compare the geographic region associated with the email message and/or communication message to determine whether the email message and/or communication message should be quarantined, blocked, or otherwise marked.

A risk score or metric for each of the emails and/or communication messages is determined based on a scoring function. For example, in one embodiment, the scoring function is based on a weighted sum or linear combination of individual scores attributed to two or more factors, such as domain age, geographic zone, and/or registrar identity. In one variation of this embodiment, each of these factors is weighted equally. In one variation, the domain age is weighted substantially more than geographic zone and registrar identity, with the sum total of the weights equaling one. For example, the domain age is weighted at least twice as much as the geographic zone and at least twice as much as the registrar identity. For instance, a normalized domain age is weighted at 0.5 and the geographic zone and registrar identity are each weighted at 0.25. In another embodiment, the domain age is weighted at 0.70 and the geographic zone and registrar identity are each weighted at 0.15. In some embodiments, at least one of the three weights is zero or substantially zero to essentially remove one of the factors from the risk calculus.

In some embodiments, it is determined if the determined risk score(s) satisfies a predetermined condition. For example, if the risk score is greater than a predetermined threshold, the email is quarantined or marked as suspicious.

One or more of the emails and or communication messages that have not been already been quarantined and/or blocked are delivered and/or transmitted to the intended recipients and/or destination. For those that have not been marked as suspicious, the exemplary embodiment, permits “normal” hyperlinking from links within the message to external content. For those emails and/or communication messages that have been marked as suspicious, the emails and/or communication messages are processed in such a way to prevent direct access to any websites or other linked content or executable files associated with the emails and/or communication messages. (Note that some embodiments operate beyond the email context to screen access to any domains or URLs or external resources, such as apps that have associated domains that can be investigated.) In some embodiments, this requires opening the email and/or communication message within a special high security or firewalled area or virtualized environment (e.g., public cloud, private cloud, etc.) or other isolated area that prevents access to systems and/or resources normally accessible via unsuspicious emails.

Notably, one or more portions of the exemplary method may be included as machine executable instructions within an application for a mobile computing devices, such as a smartphone or tablet or laptop computer, or an application for a desk top computer. Indeed, one or more portions of the method may also be included within any device with an external communication capability that enables it to connect to external content as part of a filtering or screen function that can limit access to the external resources or content. One or more portions may also be included within network switches, internet routers (both commercial and residential), Unified Threat Management (UTM) systems and devices, firewall systems and devices, antivirus systems and devices, network/host intrusion detection systems and devices, honeypot systems and devices, bastion systems and devices, etc.

Some embodiments of the access screening methodology employ semantic analysis and/or other linguistic or textual analysis criteria to email content and/or associated website content to determine a risk score. For example, content of prior known malicious emails can be analyzed to determine grammatical or linguistic patterns or word co-occurrence patterns or “fingerprints.” Or some embodiments may determine keyword type similarity measures of a given email message to a library of known malicious emails, and then quarantine emails or restrict access to content that is deemed too similar to one or more prior malicious emails.

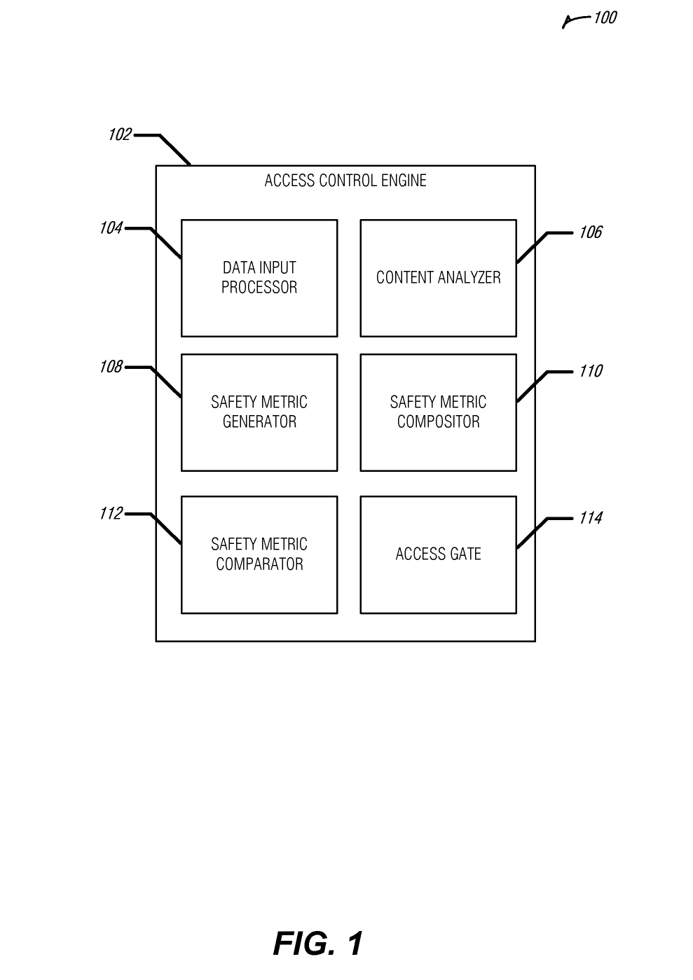

FIG. 1 illustrates a block diagram of an example system 100 for preventing access to malicious content (e.g., websites, etc.), according to an embodiment. The system 100 includes an access control engine 102 containing various components such as a data input processor 104 to receive input data and route the input data to other components of the access control engine 102. For example, the data input processor 102 may receive communication message data (e.g., an email message, instant message, DNS lookup, MX lookup, website request, URL, html code, etc).

The access control engine 102 may include a content analyzer 106 for examining the content of the communication message data. For example, the content analyzer may inspect the headers and/or body of an internet message or the contents of a website request (e.g., packet headers, html code, etc.). In an example, the content analyzer 106 may perform a whois lookup using the content of the received data to gather internet domain information associated with the communication message. For example, a message header may include the message sender's domain and the content analyzer 106 may query the whois database to determine, for example, a domain registrar, a domain registrant, a reseller associated with the domain, a domain age (e.g., how long the domain has been registered), and an IP address associated with the domain.

The access control engine may include a safety metric generator 108 for generating various metrics for the communication message by comparing attributes gathered by the content analyzer 106 to a black list (e.g., known malicious sites) or gray list (e.g., suspicious sites) to create a metric for each of the attributes. For example, if the domain registrar is matched to the black list the message sender's domain registrar attribute may have a metric of “blocked.” For example, if the domain registrant is matched to the black list the message sender's domain registrant attribute may have a metric of “blocked.” For example, if the domain IP address is matched to the black list the message sender's domain IP address attribute may have a metric of “blocked.” In an example, a private blacklist may be created by collecting threat data gathered by users of the system and aggregating the user data to construct lists of known good, known bad, and suspicious content and/or content providers. In an example, the user data may be gathered automatically and/or may be self-reported by the users.

In an example, the metric may be created by comparing an attribute value to a threshold. For example, a value of the domain age attribute may be compared to a threshold and if the value falls on one side of the threshold the domain age attribute may have a metric of “blocked” and if the value of the domain age falls on the other side of the threshold the domain age attribute may have a metric of “not blocked.”

In an example, the safety metric generator may assign a metric by evaluating geographic information associated with the communication message. For example, the IP address associated with the domain of a communication message may indicate that the domain is hosted in a geographical location hosting a disproportionate number of malicious domains in which case the domain IP address attribute may be assigned a metric of “blocked.”

The metrics are aggregated to generate a weighted metric and/or risk score for the communication message. Some individual metrics may be more indicative of a malicious site than others. A risk score or metric for each of the communication messages may be determined based on a scoring function. For example, in one embodiment, the scoring function is based on a weighted sum or linear combination of individual scores attributed to two or more factors, such as domain age, geographic zone, and/or registrar identity. In one variation of this embodiment, each of these factors is weighted equally. In one variation, the domain age is weighted substantially more than geographic zone and registrar identity, with the sum total of the weights equaling one. For example, the domain age is weighted at least twice as much as the geographic zone and at least twice as much as the registrar identity. For instance, a normalized domain age is weighted at 0.5 and the geographic zone and registrar identity are each weighted at 0.25. In another embodiment, the domain age is weighted at 0.70 and the geographic zone and registrar identity are each weighted at 0.15. In some embodiments, at least one of the three weights is zero or substantially zero to essentially remove one of the factors from the risk calculus.

The access control engine 102 may include a safety metric comparator 112 to compare the score or metric to a safety metric model. In an example, the safety metric comparator 112 may evaluate the composite safety metric to determine whether the composite safety metric is within a designated range of composite safety metrics. For example, a composite safety metric falling between 0 and 1 may classify the communication message as not blocked and a composite safety metric above 1 may classify the communication message as blocked.

The access control engine 102 may include a access gate 114 that enables and/or disables communication on the network and/or at a network interface controller of a device. The access gate 114 may determine whether to open or close communication pathways based on information received from the safety metric comparator 112. In an example, communication may be enabled for a communication message classified as not blocked. In an example, communication may be disabled for a communication message classified as blocked.

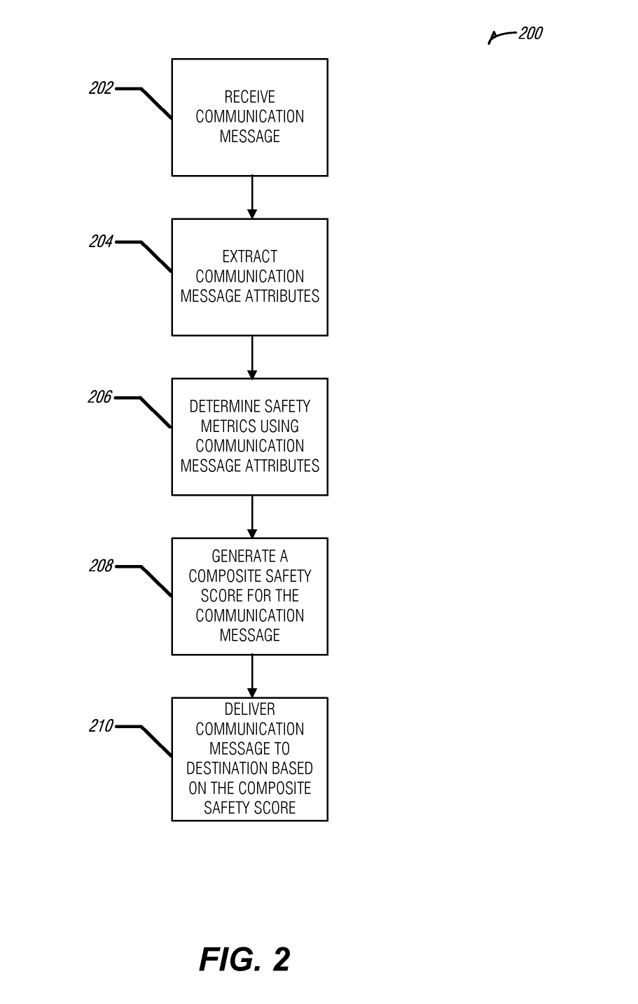

FIG. 2 illustrates a flow diagram of an example method 200 for preventing access to malicious content (e.g., websites, etc.), according to an embodiment.

At operation 202, one or more communication messages (e.g., email message, website request, access request, etc.) are received by a messaging server (e.g., an email server, proxy server, network security appliance, network security software, or other device). In an example, the one or more communication messages can be received by a filtering system that takes form of cloud, enterprise email server, and/or app (or other form of software or set of machine-executable instructions) on a network communication device (or network connected or network aware device).

At operation 204, information is extracted from each of the received communication messages. Examples of extracted information may include sender address, sender domain name, return path information, IP addresses, and embedded hyperlinks. In some embodiments, the information is extracted from the header of each communication message. In an example, the information may be extracted from the content (e.g., embedded application, hyperlink, webpage embedded content, data packet contents, etc.) of the communication message.

At operation 206, information from public whois data is retrieved or otherwise accessed based on one or more portions of the extracted information or information derived or inferred from the extracted information. Exemplary whois data may include registrar, registrant, reseller, domain age data, IP addresses. Some embodiments may also retrieve or access domain usage data or statistics.

In some embodiments, it may be determined if one or more portions of retrieved information are listed on a private or public black/gray list of offenders or suspected offenders or other list of quarantined senders. If one or more portions of the retrieved information is listed on one or more of these lists, the communication message is quarantined and/or blocked. In some embodiments, the communication message may be tagged or otherwise marked as suspicious, rather than being quarantined and/or blocked.

In some embodiments, it may be determined if one or more domains associated with the communication message satisfy one or more predetermined age criteria or conditions. For example, some embodiments determine whether one or more of the domains associated with a communication message satisfy a minimum age requirement. If age criteria is not satisfied, the communication message is quarantined, blocked, or marked as suspicious.

In some embodiments, it may be determined whether one or more IP addresses associated with the communication message satisfy one or more predetermined geographic criteria or conditions. For example, one embodiment determines if the IP address is within or without a predetermined geographic region, for example a region known for originating malicious attacks. If the IP address meets the predetermined geographic criteria, then the communication message is quarantined, blocked, or otherwise marked. In an example, the communication message may be quarantined, blocked, or otherwise marked if the geographic region is flagged as outside a geographic region the user would communicate with (e.g., a region having a different language than the user, a region outside the user's typical business operations, etc.). In an example, the user's geolocation data may be collected and used to compare the geographic region associated with the email message and/or communication message to determine whether the email message and/or communication message should be quarantined, blocked, or otherwise marked.

In some embodiments, a query may be generated based on the body and/or contents of a communication message. In an example, the query is executed against a database of known malicious emails and a metric and/or risk score is generated based on a similarity of the communication message body and/or contents to one or more known malicious emails and/or known malicious content items. For example, the database may include known malicious email that attempts to appear as if it is from a financial institution, but contains typographical errors. In the example, the body of a received email may be compared using semantic analysis to determine that the email contains the same typographical errors as the known malicious email and, thus, the email is tagged as suspicious and/or quarantined.

At operation 208, a composite safety score is determined for each of the communication messaged based on a scoring function. For example, in one embodiment, the scoring function is based on a weighted sum or linear combination of individual scores attributed to two or more factors, such as domain age, geographic zone, and/or registrar identity. In one variation of this embodiment, each of these factors is weighted equally. In one variation, the domain age is weighted substantially more than geographic zone and registrar identity, with the sum total of the weights equaling one. For example, the domain age is weighted at least twice as much as the geographic zone and at least twice as much as the registrar identity. For instance, a normalized domain age is weighted at 0.5 and the geographic zone and registrar identity are each weighted at 0.25. In another embodiment, the domain age is weighted at 0.70 and the geographic zone and registrar identity are each weighted at 0.15. In some embodiments, at least one of the three weights is zero or substantially zero to essentially remove one of the factors from the risk calculus.

In some embodiments, it may be determined if the determined risk score(s) satisfies a predetermined condition. For example, if the risk score is greater than a predetermined threshold, the communication message is quarantined, blocked, or marked as suspicious.

At operation 210, one or more of the communication messages that have not already been quarantined or blocked are delivered and/or permitted to flow to the destination based on the composite safety score. For those communication messages that have not been marked as suspicious, the exemplary embodiment, permits “normal” hyperlinking from links within the communication message to external content. For those communication messages that have been marked as suspicious, the communication messages are processed in such a way to prevent direct access to any websites or other linked content or executable files associated with the communication messages. (Note that some embodiments operate beyond the email context to screen access to any domains or URLs or external resources, such as apps that have associated domains that can be investigated.) In some embodiments, this requires opening the communication message within a special high security or firewalled area or virtualized environment or other isolated area that prevents access to systems and/or resources normally accessible via unsuspicious communication messages.

Notably, one or more portions of the exemplary method 200 may be included as machine executable instructions within an application for a mobile computing devices, such as a smartphone or tablet or laptop computer, or an application for a desk top computer. Indeed, one or more portions of the method 200 may also be included within any device with an external communication capability that enables it to connect to external content as part of a filtering or screen function that can limit access to the external resources or content. One or more portions may also be included within network switches, internet routers (both commercial and residential), Unified Threat Management (UTM) systems and devices, firewall systems and devices, antivirus systems and devices, network/host intrusion detection systems and devices, honeypot systems and devices, bastion systems and devices, etc.

Some embodiments of the access screening methodology employ semantic analysis and/or other linguistic or textual analysis criteria to communication message content and/or associated website content to determine a risk score. For example, content of prior known malicious communication messages and/or content items can be analyzed to determine grammatical or linguistic patterns or word co-occurrence patterns or “fingerprints.” Or some embodiments may determine keyword type similarity measures of a given communication message and or communication message content item to a library of known malicious communication messages and/or content items, and then quarantine, block, or restrict access to communication messages or content items that are deemed too similar to one or more prior malicious communication messages or content items.

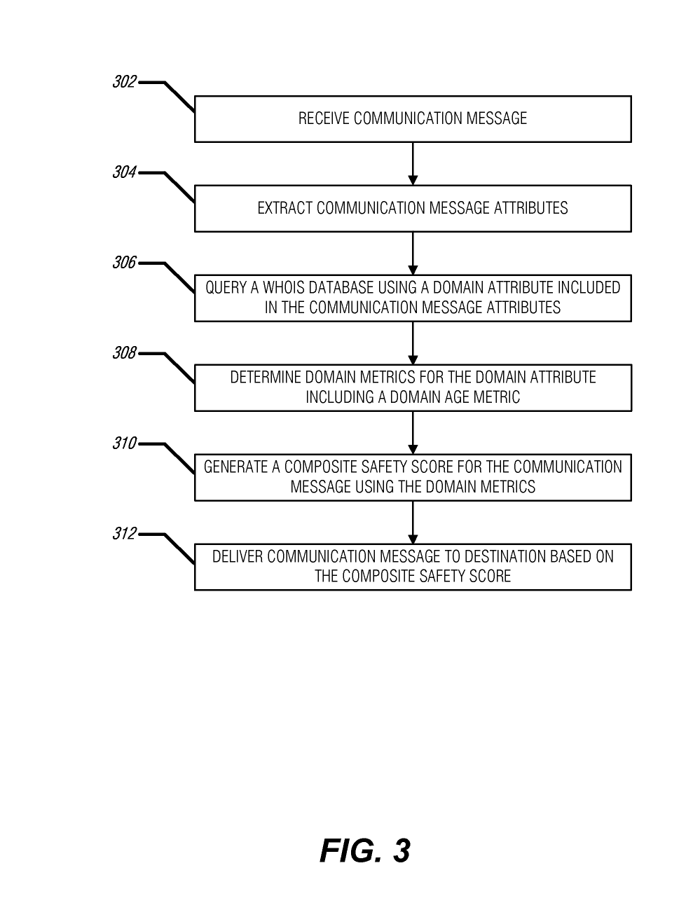

FIG. 3 is a flow diagram of an example method 300 for preventing access to malicious content (e.g., websites, etc.), according to an embodiment of the present subject matter.

At operation 302, one or more communication messages (e.g., email message, website request, access request, etc.) are received by an email server, proxy server, network security appliance, network security software, or other device. In an example, the one or more communication messages can be received by a filtering system that takes form of cloud, enterprise email server, and/or app (or other form of software or set of machine-executable instructions) on a network communication device (or network connected or network aware device).

At operation 304, information is extracted from each of the received communication messages. Examples of extracted information may include sender address, sender domain name, return path information, IP addresses, and embedded hyperlinks. In some embodiments, the information is extracted from the header of each communication message. In an example, the information may be extracted from the content (e.g., embedded application, hyperlink, webpage embedded content, data packet contents, etc.) of the communication message.

At operation 306, information from public whois data is retrieved or otherwise accessed based on one or more portions of the extracted information or information derived or inferred from the extracted information. Exemplary whois data may include registrar, registrant, reseller, domain age data, IP addresses. Some embodiments may also retrieve or access domain usage data or statistics.

At operation 308, the domain age data is evaluated to determine if one or more domains associated with the communication message satisfy one or more predetermined age criteria or conditions. For example, some embodiments determine whether one or more of the domains associated with a communication message satisfy a minimum age requirement. If age criteria is not satisfied, the communication message is quarantined, blocked, or marked as suspicious.

At operation 310, a composite safety score is determined for each of the communication messaged based on a scoring function. For example, in one embodiment, the scoring function is based on a weighted sum or linear combination of individual scores attributed to two or more factors, such as domain age, geographic zone, and/or registrar identity. In one variation of this embodiment, each of these factors is weighted equally. In one variation, the domain age is weighted substantially more than geographic zone and registrar identity, with the sum total of the weights equaling one. For example, the domain age is weighted at least twice as much as the geographic zone and at least twice as much as the registrar identity. For instance, a normalized domain age is weighted at 0.5 and the geographic zone and registrar identity are each weighted at 0.25. In another embodiment, the domain age is weighted at 0.70 and the geographic zone and registrar identity are each weighted at 0.15. In some embodiments, at least one of the three weights is zero or substantially zero to essentially remove one of the factors from the risk calculus.

In some embodiments, it may be determined if the determined risk score(s) satisfies a predetermined condition. For example, if the risk score is greater than a predetermined threshold, the communication message is quarantined, blocked, or marked as suspicious.

At operation 312, one or more of the communication messages that have not already been quarantined or blocked are delivered and/or permitted to flow to the destination based on the composite safety score. For those communication messages that have not been marked as suspicious, the exemplary embodiment, permits “normal” hyperlinking from links within the communication message to external content. For those communication messages that have been marked as suspicious, the communication messages are processed in such a way to prevent direct access to any websites or other linked content or executable files associated with the communication messages. Note that some embodiments operate beyond the email context to screen access to any domains or URLs or external resources, such as apps that have associated domains that can be investigated. For example, a non-malicious application may receive malicious content that it may try to forward across the network, the content of the application's request may be processed to determine whether to quarantine, block, or otherwise mark the request. In some embodiments, this requires opening the communication message within a special high security or firewalled area or virtualized environment or other isolated area that prevents access to systems and/or resources normally accessible via unsuspicious communication messages.

Notably, one or more portions of the exemplary method 200 may be included as machine executable instructions within an application for a mobile computing devices, such as a smartphone or tablet or laptop computer, or an application for a desk top computer. Indeed, one or more portions of the method 200 may also be included within any device with an external communication capability that enables it to connect to external content as part of a filtering or screen function that can limit access to the external resources or content. One or more portions may also be included within network switches, internet routers (both commercial and residential), Unified Threat Management (UTM) systems and devices, firewall systems and devices, antivirus systems and devices, network/host intrusion detection systems and devices, honeypot systems and devices, bastion systems and devices, etc.

Some embodiments of the access screening methodology employ semantic analysis and/or other linguistic or textual analysis criteria to communication message content and/or associated website content to determine a risk score. For example, content of prior known malicious communication messages and/or content items can be analyzed to determine grammatical or linguistic patterns or word co-occurrence patterns or “fingerprints.” Or some embodiments may determine keyword type similarity measures of a given communication message and/or communication message content item to a library of known malicious communication messages and/or content items, and then quarantine, block, or restrict access to communication messages or content that are deemed too similar to one or more prior malicious communication messages or content items.

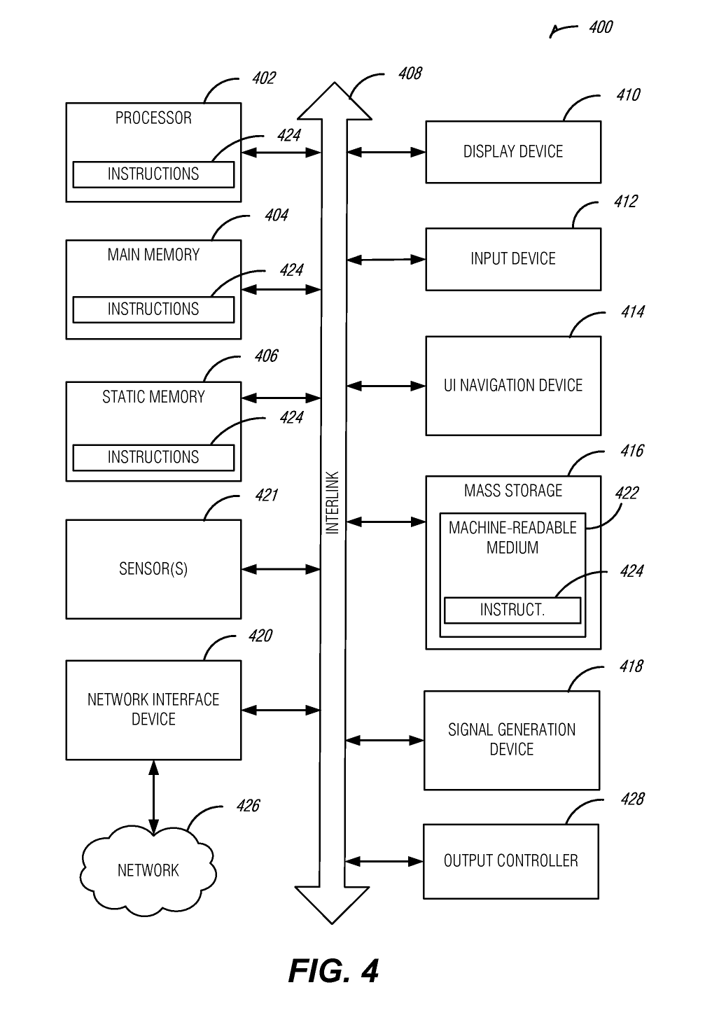

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

### ADDITIONAL NOTES

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A system comprising:
one or more network communications devices capable of sending and receiving communication messages and connecting with one or more external resources via an IP protocol; and
a messaging server configured to process communication messages for the one or more network communications devices, the server including a processor coupled to a memory, the memory including one or more instructions for blocking communication messages based at least on age of a domain associated with a communication message.

2. The system of claim 1, wherein the memory further includes one or more instructions for blocking communication messages based at least on geographic region associated with an IP address.

3. The system of claim 1, wherein the memory further includes one or more instructions for blocking communication messages based at least on identity of a domain name registrar associated with a domain associated with a communication message.

4. The system of claim 1, wherein the communication message includes a URL.

5. The system of claim 4, wherein the memory further includes one or more instructions for restricting access to the URL based at least on age of a domain associated with the URL.

6. The system of claim 4, wherein the memory further includes one or more instructions for restricting access to the URL based at least on geographic region associated with an IP address

7. The system of claim 4, wherein the memory further includes one or more instructions for restricting access to the URL based at least on identity of a domain name registrar associated with a domain associated with the URL.

8. A method comprising:
receiving a communication message containing content;
generating a query based on the content of the communication message;
executing the query against a database of known malicious content items and generating a score based on similarity of the communication message content to one or more of the known malicious content items; and
determining whether to block the communication message based on the score relative to a predetermined threshold.

9. The method of claim 8, wherein the communication message is blocked based at least on age of a domain associated with the email message.

10. The method of claim 8, wherein the communication message is blocked based at least on the age of the domain and a geographic region associated with an IP address.

11. The method of claim 8, wherein the communication message is blocked based at least on the age of the domain and identity of a domain name registrar associated with the communication message.

12. The method of claim 8, wherein the content of the communication message includes a URL.

13. The method of claim 8, further comprising restricting access to the URL based at least on age of a domain associated with the URL.

14. A non-transient machine readable medium comprising one or more machine instructions for:
quarantining communication messages based at least on age of a domain associated with a communication message.

15. The medium of claim 14 further comprising one or more instructions for blocking communication messages based at least on geographic region associated with an IP address.

16. The medium of claim 14 further comprising one or more instructions for blocking communication messages based at least on identity of a domain name registrar.

17. The medium of claim 14, wherein the communication message includes a URL.

18. The medium of claim 17, further comprising one or more instructions for restricting access to the URL based at least on age of a domain associated with the URL.

19. The medium of claim 17, further comprising one or more instructions for restricting access to the URL based at least on geographic region associated with an IP address associated with a domain of the URL.

20. The medium of claim 17, further comprising one or more instructions for restricting access to the URL based at least on identity of a domain name registrar associated with the URL.
